(19) United States
(12) Patent Application Publication
(10) Pub. No.: US 2014/0310135 A1
(43) Pub. Date: Oct. 16, 2014

(54) WARDROBE STORAGE

(71) Applicant: Mounissa Chodieva, London (GB)

(72) Inventor: Mounissa Chodieva, London (GB)

(21) Appl. No.: 13/852,034

(22) Filed: Mar. 28, 2013

Related U.S. Application Data
(60) Provisional application No. 61/619,509, filed on Apr. 3, 2012.

(51) Int. Cl. G06Q 10/08

(52) U.S. Cl. CPC G06Q 10/087
USPC 705/28

(57) ABSTRACT

A wardrobe storage and despatch facility having a clothes store for storing clothing and accessories for users. A database of the clothes and accessories belong to each user is provided, including data identifying the owner of each item of clothing and whether the clothes are in the clothes store or have been despatched elsewhere. The users have access to the database, from which they can select clothes for despatch from the clothes store to locations where they are to be worn, or for collection from a remote location to be returned to the clothes store. Users can also request cleaning and repair of their clothing items.

This application claims priority to U.S. Provisional patent application 61/619,509 filed Apr. 3, 2012 and entitled, “Wardrobe Storage.”

The present invention relates to wardrobe storage.

Airline travel provides the facility for people to travel to many destinations in succession. Nevertheless there are limitations on baggage. Where the destinations are of a variety of types, requiring formal & informal clothes and tropical & winter clothes, the volume of baggage for the travels can be excessive. Further, city living places constraints on the wardrobe storage at home for people having a varied life style within and without the city.

The present invention has been conceived to address these problems.

It is known from U.S. Pat. No. 5,651,677 to provide in accordance with its abstract:

A wardrobe management system having a log book in a calendar format with specified areas therein for recording garment identification and alpha-numeric information, a plurality of garment marking tags having garment type and numerical information recorded thereon, a plurality of fastening devices for use in removably securing marking tags to garments without permanent damage to the garments, and at least one storage container for housing the marking tags, the fastening devices, and small garment accessories, such as suit pocket handkerchiefs, jewellery, and scarves. Applications may include, but are not limited to, use in organising men's and women's business wardrobes to ensure no repetition of clothing worn at functions attended by the same groups of people. This does not envisage storage remote from the place of wearing of the garments; nor despatch of garments to a destination where they will be worn.

Again, it is known from International application No. WO 2005/111877 to provide in accordance with its abstract:

The invention relates to an intelligent wardrobe management system for advising appropriate clothing to a user. It comprises a wardrobe controller which is arranged to: receive input data, said input data comprising information about the clothing in a wardrobe; receive user data process said input data and said user data; and output, on the basis thereof, a clothing proposal to the user. The system facilitates and accelerates the user's access to the wardrobe.

Again, this does not envisage storage remote from the place of wearing of the garments; nor despatch of garments to a destination where they will be worn.

The object of the present invention is to improve wardrobe storage.

According to a first aspect of the invention there is provided a wardrobe storage and despatch facility comprising:

a clothes store for storing clothes belonging to a plurality of users,

a database of the clothes belonging to the users, the database including data at least identifying each clothes item belonging to each user and as to whether the items are in the store or have been despatched elsewhere and

means for a user to select remotely clothes for despatch from the store to a location where they are to be worn.

Preferably the selection means includes a website saved on a server and able to be accessed by users to enable them to select clothes for despatch from the store to a location where they are to be worn. Advantageously the website will be interactive for receiving instructions and acknowledging receipt of them.

Preferably, the clothes are all marked with a unique mark, typically a barcode label, for ease of checking in despatch from and return to the store. Accordingly at least one barcode reader will normally be associated with the clothes store.

The store is preferably air conditioned for storing the clothes in a suitable atmosphere, without excesses of temperature or humidity.

The database will preferably include:

the history of each clothes item, normally including when and whence it was acquired by the user;

at least one photograph of each clothes item;

any special storage and/or treatment conditions for it;

each date on which the user requested it to be despatched to be worn and where to;

when and whence it was returned and any special requests on its return;

when it was cleaned, repaired and/or altered; and

when it was disposed of

The database can be kept in a memory of a server located within the store or in a memory of a remote server.

The website can be kept on a memory of a different server, but is preferably on the same server as the database. Each user will have a unique user name and password, to allow access to that user's clothes details on the website. The website will enable the user to select any clothes item and specify:

when and whither it is to be despatched from storage;

special instructions such as which accessories, e.g. belts, are to be included;

when and whence it and the accessories are to be collected;

cleaning, repair, alteration;

disposal and manner of disposal, e.g. sale or gift.

According to a second aspect of the invention there is provided a method in the storage and despatch of clothes for users, the method consisting in the steps of:

storing clothes belonging to a plurality of users in a store;

providing a database of the clothes belonging to the users;

receiving user selections of clothes to be worn and specifications of where they are to be worn and when;

receiving user selected clothes from the store; and

despatching them to the specified places where they are to be worn in time for them to be worn there when specified.

Preferably the method further includes:

receiving instruction of when the clothes are to be collected from the place of wearing and whether they are to be returned to storage or sent for wearing elsewhere;

collecting them as instructed; and

returning them to storage or forwarding them to be worn elsewhere.

Further the method includes

receiving cleaning and/or repair instructions with collection instructions; and

cleaning and/or repairing the clothes as instructed.

To help understanding of the invention, a specific embodiment thereof will now be described by way of example and with reference to the accompanying drawings, in which:

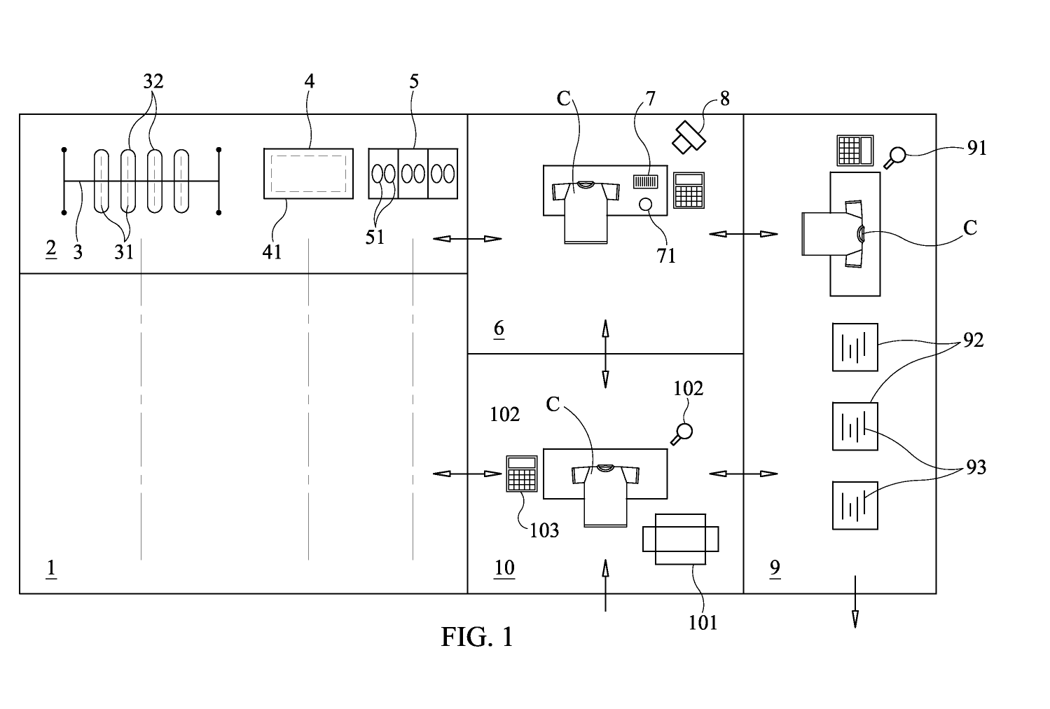

FIG. 1 is a diagrammatic plan of a wardrobe storage and despatch facility in accordance with the invention;

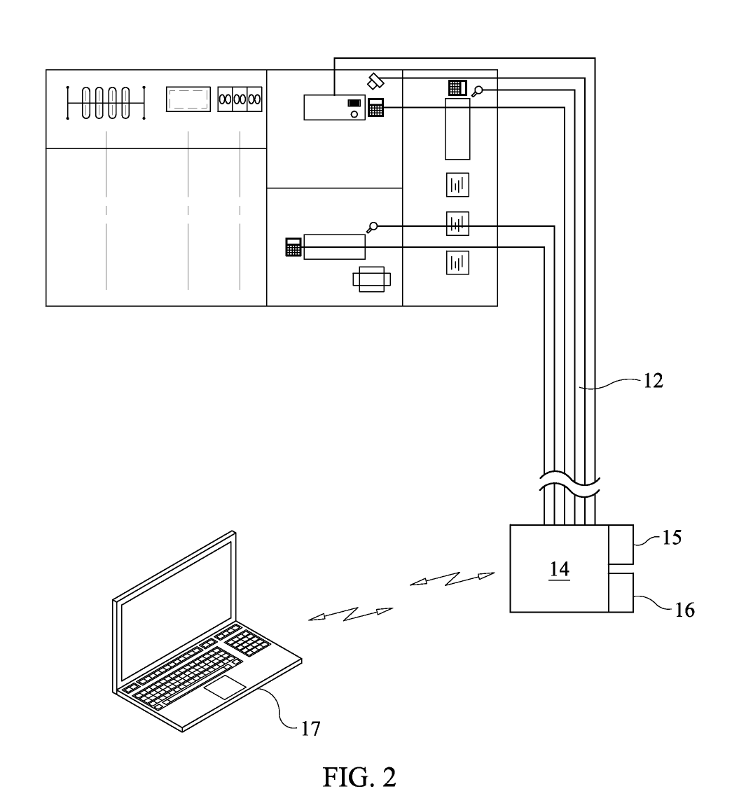

FIG. 2 is a block diagram of the information technology elements of the facility of FIG. 1;

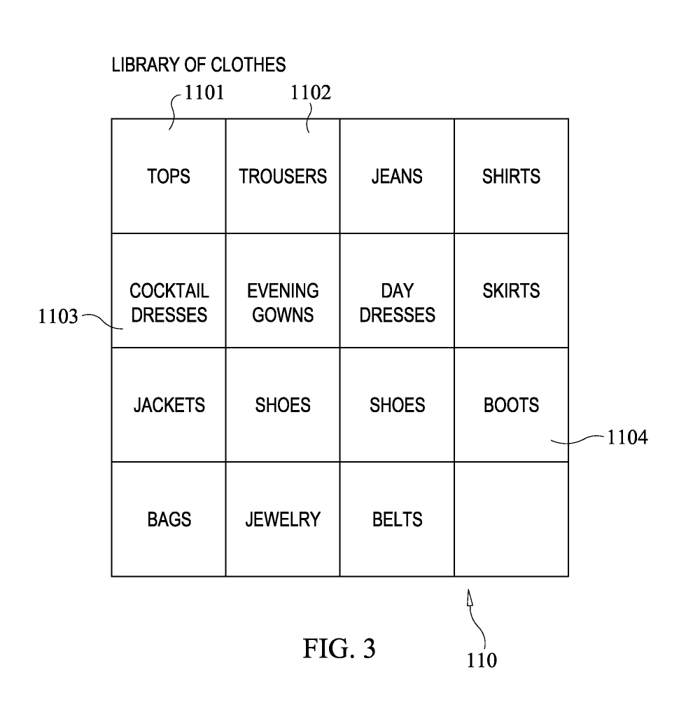

FIG. 3 is a view of a webpage from the website of the invention showing the classifications of clothing for a user;

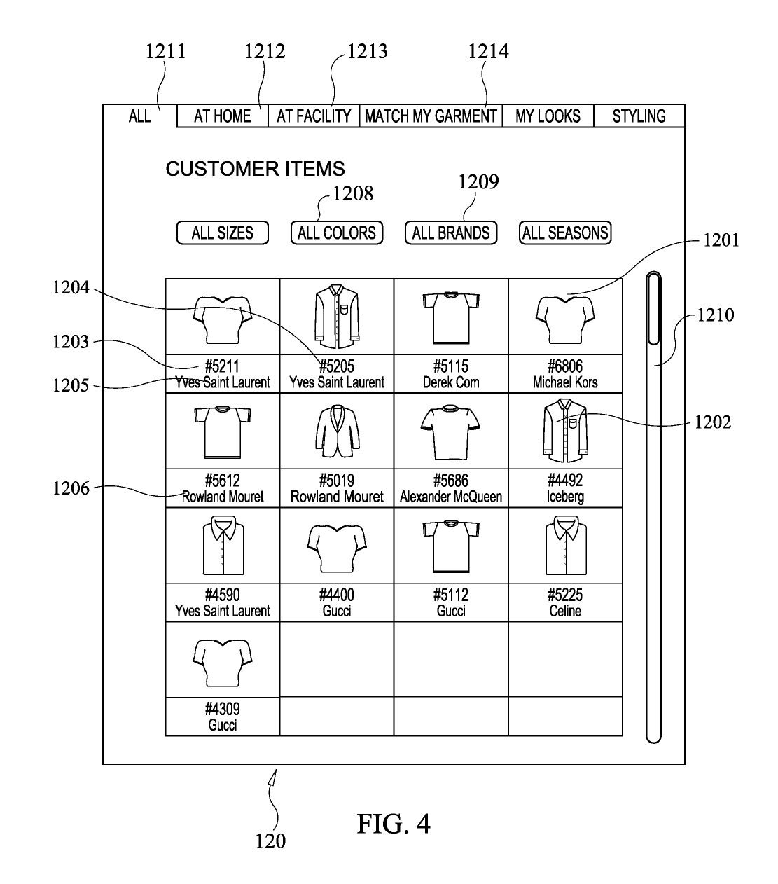

FIG. 4 is a view of a further webpage showing items of clothing in one classification;

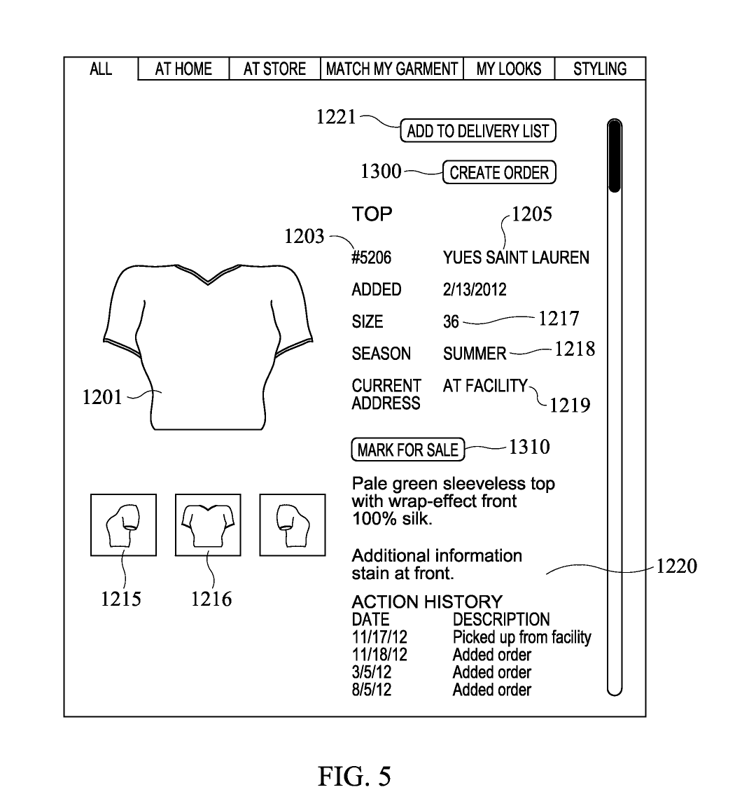

FIG. 5 is a view of a further webpage relating to one item;

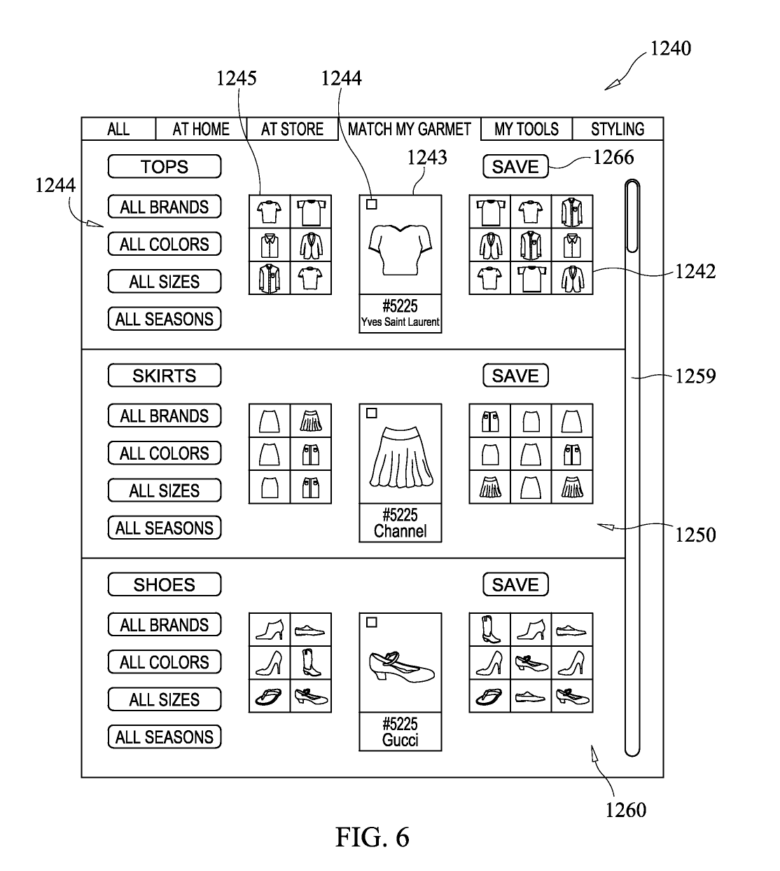

FIG. 6 is a webpage relating to the MATCH MY GARMET feature;

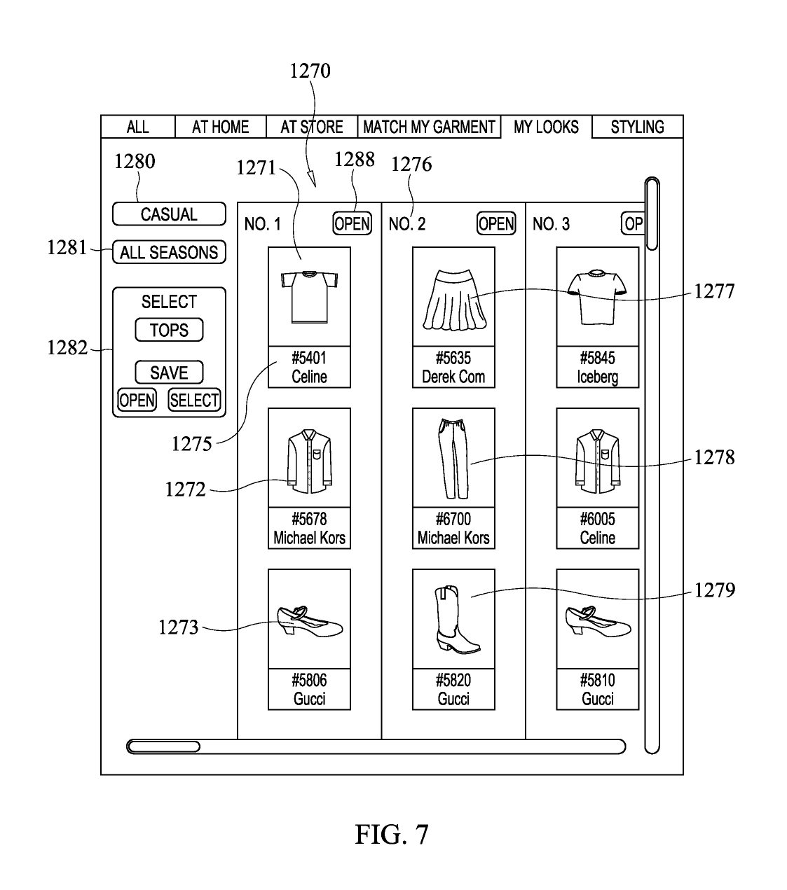

FIG. 7 is a webpage relating to the MY LOOKS feature;

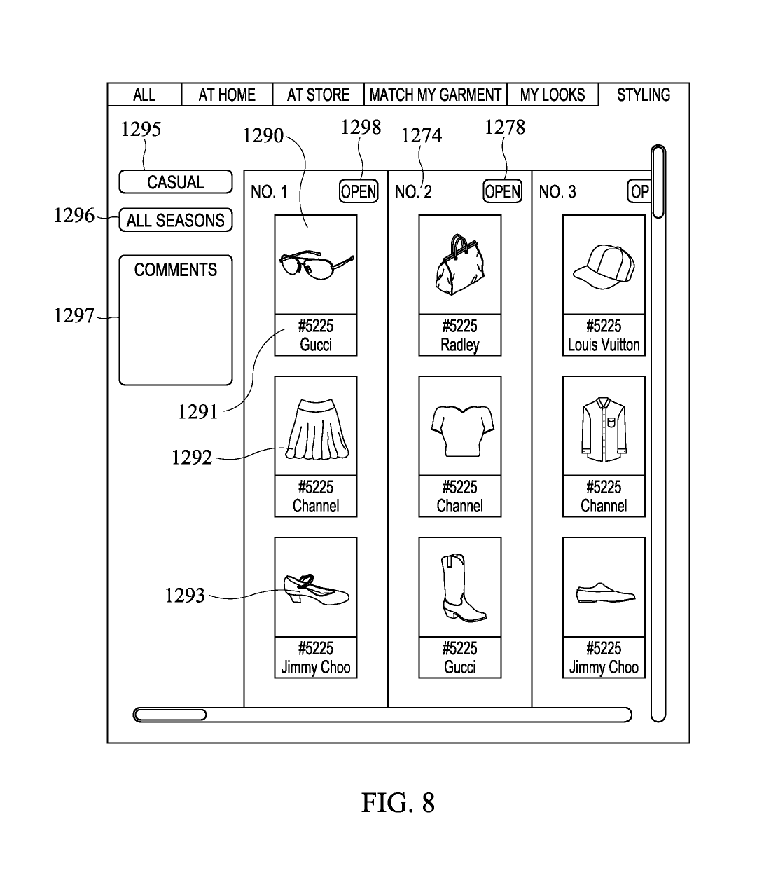

FIG. 8 is a webpage relating to the STYLING feature; and

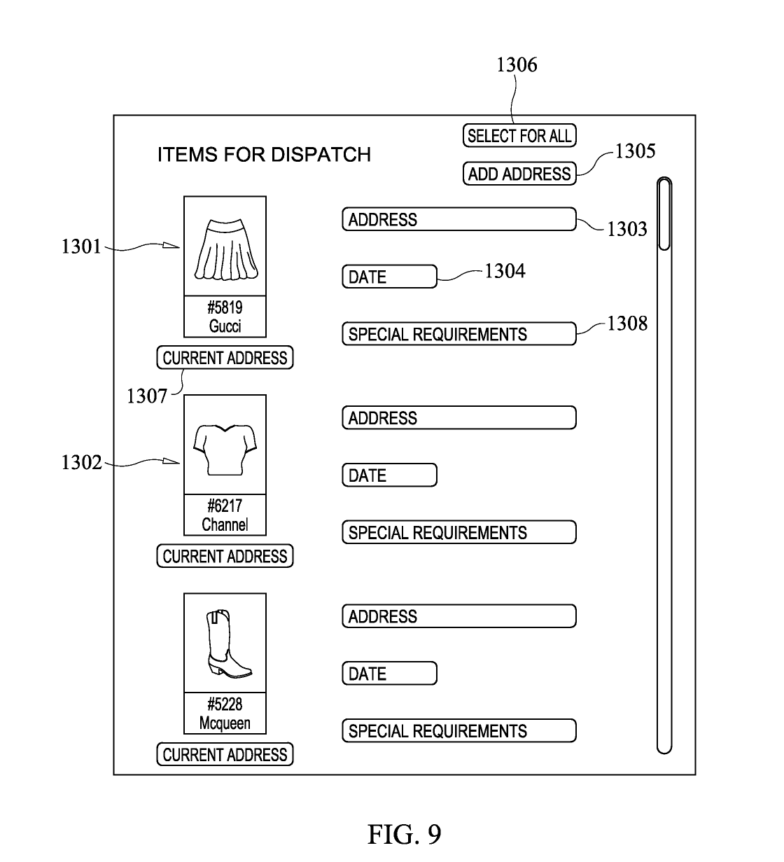

FIG. 9 is a webpage relating to the despatch of chosen items.

Referring to the drawings a wardrobe storage and despatch facility is shown diagrammatically as comprising:

an air-conditioned storage room 1, sub-divided into areas 2 for each user.

Hanging rails 3, with hangers 31 and dust-proof bags 32, chests of drawers 4 with tissue paper 41 for clothes and accessories and shoe racks 5 with shoes trees 51 are included;

a work-room 6 in which barcode labels 7 are stitched into clothes C. A bar code reader 71 is provided. The clothes are photographed with a camera 8 when added to the user's wardrobe. Simple repairs and alterations are also effected by seamstresses in the work-room;

a despatch room 9 where clothes are packed for despatch, having been carefully checked including with a bar code reader 91 and their packages 92 labelled with destination addresses 93;

a return room 10 where the clothes are unpacked from return packages 101 and again checked including with a bar code reader 102. After checking the clothes are either returned direct into the storage room, repaired in the work room or passed to the despatch room for sending for cleaning or repair by external tailors. Every event is logged either directly with the bar code reader and/or with a keyboard and screen 103 associated with the reader;

a data bus 12 to a server 14 having a memory 15 on which all clothes events are logged in the facility's clothes database;

a further memory 16 in which a website is stored. This is accessible remotely by a user using a mobile device 17.

In use, the user enters a unique username and password. When logged in the user can specify wardrobe items to be sent to specified destinations to be worn on specified dates and then collected for return thereafter. Thus the user is able to travel light. Special instructions such as cleaning, repair or alteration can be given, or this can be left to the discretion of the facility's staff.

Referring now to FIG. 3-8, the website enables users to review their clothing, and to provide instructions to despatch clothes items to a location where they are to be worn, to collect clothes items from locations, to clean items of clothing, to repair items of clothing, or to sell items of clothing.

Initially, in order to manage their clothing, namely their clothes, accessories and footwear, a user will send all of the clothing they wish managed to the facility, where it will be received, and immediately passed to the work-room 6 for logging, including insertion of a barcode label 7. Each item of clothing is photographed on the camera 8, and is entered on the database, identified with the barcode details. Each item will be photographed from at least four angles and photographs of the labels 7 will also be taken.

On the database each item of clothing is identified using the barcode number, and other pieces of information regarding the item are also stored. In particular each item is classified according to whether it is a top, trousers, jeans, suits, cocktail dresses, boots, jewellery, or any other type of clothing or accessory. The classifications can be adapted to suit the user. In addition the colour of the item, its season or seasons for wear, its brand, its size, and the date on which it was acquired can also be logged. Generally a description of the item will also be stored, for example “Brown woollen dress with V-shaped cutout at neck, slit front pockets, cropped sleeves with slits, V-neck at back, back slit, concealed zip and hook fastening at back, fully lined. 100% wool.” The database can also store a history for the item of clothing, including dates of shipment to places where it is to be worn, and dates of return to the facility. In addition special storage requirements, or cleaning requirements, can also be stored.

When logged on to the database, with their unique username and password, the user is initially presented with webpage 110 having an array of boxes for the various classifications of clothing as identified above, for example, tops 1101, trousers 1102, jeans, suits, cocktail dresses 1103, boots, jewellery 1104, as shown in FIG. 3.

Referring now to FIG. 4, once the user has chosen one of the classifications by clicking the appropriate box, she is the presented with a further webpage showing all of the items in that classification. Each item is shown by a photograph 1201, 1202, identified by its identifier (namely its barcode number) 1203, 1204, and by its brand 1205, 1206. Initially the webpage shows all of the items in the classification. However, the user is able to limit the items shown according to various categories, such as size, colour, brand or season. In order for the user to limit the items shown in these categories, drop down boxes, 1208, 1209 are provided. This can allow the user to select items, for example, for the spring season, in white, yellow or cream, from brands Victoria Beckham, Alexander McQueen, or Christian Dior, and in all sizes, or alternative all items for the summer season, in red, in size 6, from all brands. The size of the photographs 1201, 1202 is chosen so that the user can see the item clearly, and as a result a limited number can be displayed on a standard screen of a users remote device 17. A scroll bar 1210 is therefore provided to enable the user to view all the items in that classification.

In addition the webpage is provided with tabs which give the user further options. The first tab 1211 is for all of the items to be shown. Further tabs are provided for showing all of the items at the users home 1212 (or at one particular selectable location, for example where a user has more than one home), and for showing all of the items at the storage facility 1213.

Once the user has chosen an item of clothing, they can click on the box showing the item 1201, which opens up a new webpage in which full details of this item are shown, as shown in FIG. 5. The photograph 1201 of the item is again shown, but larger, and other photographs 1215, 1216 of the items from the sides and back can also be provided. As discussed above, usually at least four photographs of each item are taken and can be shown in this page. The identifier for the item 1203 and the brand 1205 are also shown. Details relating to the item including its size, 1217, season 1218, and current address 1219, are also shown. The database will store a series of addresses for each user, typically their home address, or each of their home addresses, and locations at which they regularly stay, for example particular hotels. A history of the item 1220 is also shown. Importantly a click box 1221 is provided to enable the user to add the item to a list for despatch, cleaning, repair or sale. In addition a button 1300 is provided to take the user to a page whereby she can indicate to the facility to where clothes are to be despatched and when.

Another facility provided on the website is the option to select clothes that co-ordinate. A user can chose the “MATCH MY GARMENTS” tab 1214, which enables them to chose a number of garments of different classifications at the same time. A first section 1240 is for selecting one classification of item, for example tops. Drop down selector box 1241 allows a user to decide whether she wishes to chose the tops first or to chose another classification. She is then able to limit her selection by selecting from the other drop down boxes for brands, colours, sizes and seasons, in a similar way to that described above.

The group of items selected are shown in an array 1242 on the right hand side of the screen. The user is then able to select from this group. As the photographs in this array are so small, once the use has made a selection, a larger photograph of the item is displayed in a box 1243 in the middle of the section. As usual the item is displayed with a photograph, together with its identifier number and brand. Once the user has decided that this is an item to be selected this can be selected using button 1244, which then displays the item in the selected items array 1245. One, two or more items may be selected. The user will then move to the next section 1250, where choices will be made in a similar manner. Similarly with section 1260. Further sections may also be provided, moving down the screen with the slider, 1259. This enables a user to select clothes that go together, and by selecting the same range of colour and season can more easily create outfits. Once a number of items have been selected and moved into the left hand arrays 1245, a save button 1266 can be pressed which selects all of the chosen items and adds them to the list for despatch, collection, cleaning, repair or sale. This enables a user to select outfits, or groups of clothes that work together.

A further tab is provided as shown in FIG. 7, entitled MY LOOKS. This stores suggestions for outfits, based on combinations of clothes worn together before, or with co-ordinating colours and season information. FIG. 7 shows two selections. No. 1 1270 shows a dress 1271 with a jacket 1272 and high healed shoes 1273. As before each item is shown by its photograph 1274, and its identification number together with the brand of the item 1275. This selection has previously been made and probably worn before. Similarly selection No. 2 1276 shows a top 1277 with trousers 1278 and boots 1289. The selections can be stored according to where they would be worn and the season. Button 1280 allows a user to select the type of occasion, for example casual, city wear, beach wear, sailing, dinner, and button 1281 allows a user to select the season for the outfit. The user can make new selections using the select button 1282. This allows the user to choose items form several classifications and then store them as a selection. Once the selection has been made the use can press a save button which will allow the user to save the selection as a new selection in MY LOOKS, or add the items to their chosen list. Alternatively a user can instruct the facility management to add any outfit that they have worn more than once as a selection. This allows a user to create outfits for themselves and save them, such that when they wish to select items, they can select combinations, instead of or in addition to single items.

Once a look has been chosen a user can chose an open button 1283 which shows the use photographs of the full look and allows the user to add these items to the list for dispatch.

A final tab is provided as shown in FIG. 8, entitled STYLING. This is very similar to the “MY LOOKS” tab, except that the combinations of clothes have been chosen by a stylist provided by storage facility. The combination of clothes will be based on examples of combinations chosen by a user. For example, by viewing combinations of clothes previously worn together, or stored on MY LOOKS, the stylist will be able to see how the user likes to dress, in particular whether she likes very classic combinations only, always likes to be edgy or a combination of the two.

FIG. 8 shows two selections. The first, No. 1, 1290, includes a pair of sunglasses 1291, a dress, 1292 and a pair of shoes 1293. As described previously, each item is displayed with its photograph, its identification number and brand. A second selection, No. 2, 1294, includes a handbag, a top and a skirt. Button 1295 allows the user to select the range of combinations for particular occasions, as described above. Similarly a user can chose by season, using button 1286. In addition the use can leave comments for the stylist in box 1297. Box 1298 allows the user to choose a particular combination, for example No. 1, and this combination only will then appear in a new webpage. The user can then select this combination for adding to her order.

The facilities of MY LOOKS and STYLING allow a user, and/or the stylist, to create a capsule wardrobe for a particular period of time, for example a holiday, or business trip, or to create a luggage bag.

Once the user has chosen the items to be despatched, they can press CREATE ORDER button 1290, see FIG. 5, which takes them to a despatch screen shown in FIG. 9.

This provides a list of all of the items chosen, shown as usual by their photograph, item identifier and brand, 1301, 1302. By the side of each item are two buttons, 1303, 1304. These are drop down buttons, providing selections for the user to chose from. The first button 1303 is an address button, to allow the user the chose the address to which the item should be shipped. Thus button will store a number of address; in particular a home address, the address for the facility for return of items, address of hotels which are used regularly, holiday addresses, homes in other countries. If the address to which the user wishes the goods shipped is not already stored, then the user can press button 1305 ADD ADDRESS, which will then allow the user to enter a new address.

Similarly the user can enter the date by which the items should reach the chosen address. The date can be selected by pressing button 1304, the DATE button.

If all of the items chosen are to be despatched to the same address by the same date, the user can select the address and date for the first item 1301 and then press the SELECT FOR ALL button 1306, which will add the same selection of address and date to all of the items. If alternatively the user has selected items for a number of address to be worn on different dates, for example a trip to two or more destinations, then the address and date for delivery can be chose for each item individually.

The despatch screen in FIG. 9 also provides the current address for each item shown in a button 1307 associated with each item. This allows the user to see whether all of the chosen items can be despatched from the store, or whether a special delivery order will be required to collect one of more items from a different address. Depending upon the time scale for requirement of the items this may or may not be practical. The screen can also provide a button for indicating when the items are to be collected and returned to storage.

Another option provided on the website is to allow users to sell items that they no longer use. Referring again to FIG. 5, on the page giving full details of an item, there is provided a button 1310 identified as “MARK FOR SALE”. If a user wishes to sell an item they can press this button which will then allow them to enter a price they require for the item. Other users are then able to view the item, and all items marked as for sale. Items marked as for sale will appear in the arrays of customer items, as shown in FIG. 4, but will not be able to be selected for despatch. If a user changes her mind and decides to retain the item, provided it has not been sold, she can do this.

After use, the user can request the items be collected and returned to the storage facility for storage, and for cleaning and/or repair. The user will again log on to the website using their username and password. As shown in FIG. 4, button 1212 is provided which lists all items that are AT HOME, or are actually out of the facility. The user can then select the ones to be collected. This will then take them to a screen almost identical to the one shown in FIG. 9. However, on this screen the default setting will be the facility for the address and “as soon as possible” for the collection date. The user may change the address or date for some of all of the items, for example if the user is travelling to another destination in the near future. Additional buttons 1308 will be provided to allow the user to instruct that the item be cleaned or repaired.

This allows users to manage their wardrobe without having the travel with large amounts of luggage.

1. A wardrobe storage and despatch facility comprising:
a clothes store for storing clothes belonging to a plurality of users,
a database of the clothes belonging to the users, the database including data at least identifying each clothes item belonging to each user and as to whether the items are in the store or have been despatched elsewhere; and
means for a user to select remotely clothes for despatch from the store to a location where they are to be worn.

2. A wardrobe storage and despatch facility as claimed in claim 1, wherein the means for a user to select includes a website saved on a server and able to be accessed by users to enable them to select clothes for despatch from the store to a location where they are to be worn.

3. A wardrobe storage and despatch facility as claimed in claim 2, wherein the website is interactive for receiving instructions and acknowledging receipt of them.

4. A wardrobe storage and despatch facility as claimed in claim 1, wherein the clothes are all marked with a unique mark, typically a barcode label, for ease of checking in despatch from and return to the clothes store.

5. A wardrobe storage and despatch facility as claimed in claim 4, wherein at least one barcode reader is associated with the clothes store.

6. A wardrobe storage and despatch facility as claimed in claim 1, wherein the clothes store is air conditioned for storing the clothes in a suitable atmosphere, without excesses of temperature or humidity.

7. A wardrobe storage and despatch facility as claimed in claim 1, wherein the database comprises:
the history of each clothes item, normally including when and whence it was acquired by the user;
at least one photograph of each clothes item;
any special storage and/or treatment conditions for it;
each date on which the user requested it to be despatched to be worn and where to;
when and whence it was returned and any special requests on its return;
when it was cleaned, repaired and/or altered; and
when it was disposed of.

8. A wardrobe storage and despatch facility as claimed in claim 7, wherein the database is kept in a memory of a server located with the store

9. A wardrobe storage and despatch facility as claimed in claim 7, wherein the database is kept in a memory of a remote server.

10. A wardrobe storage and despatch facility as claimed in claim 2, wherein the website is kept on a memory of a server, on which the database is kept.

11. A wardrobe storage and despatch facility as claimed in claim 2, wherein to allow a user access to clothes details on the website, each user will have a unique user name and password.

12. A wardrobe storage and despatch facility as claimed in claim 1, wherein the website will enable the user to select any clothes item and specify:
when and whither it is to be despatched from storage;
special instructions such as which accessories, e.g. belts, are to be included;
when and whence it and the accessories are to be collected;
cleaning, repair, alteration;
disposal and manner of disposal, e.g. sale or gift.

13. A method in the storage and despatch of clothes for users, the method consisting in the steps of:
storing clothes belonging to a plurality of users in a store;
providing a database of the clothes belonging to the users;
receiving user selections of clothes to be worn and specifications of where they are to be worn and when;
receiving user selected clothes from the store; and
despatching them to the specified places where they are to be worn in time for them to be work there when specified.

14. A method in the storage and despatch of clothes for users as claimed in claim 13, wherein the method further includes:
receiving instruction of when the clothes are to be collected from the place of wearing and whether they are to be returned to storage or sent for wearing elsewhere;
collecting them as instructed; and
returning them to storage or forwarding them to be worn elsewhere.

15. A method in the storage and despatch of clothes for users as claimed in claim 13, wherein the method further includes
receiving cleaning and/or repair instructions with collection instructions; and
cleaning and/or repairing the clothes as instructed.

16. A method in the storage and despatch of clothes for users as claimed in claim 13, wherein the method includes providing a website to enable users to make their selections of clothes to be worn.

17. A method in the storage and despatch of clothes for users as claimed in claim 13, wherein the method includes providing a stylist for assisting a user in making selections.

18. A method in the storage and despatch of clothes for users as claimed in claim 13, wherein the method includes storing details of aspects of the clothes including season of wear, colour, brand and size, and providing a website to enable the user to make selections.
